(19) United States
(12) Patent Application Publication
(10) Pub. No.: US 2019/0034457 A1
(43) Pub. Date: Jan. 31, 2019

(54) SHARING METHOD FOR INFORMATION INCLUDING TAG CONTENTS

(71) Applicant: Jae-hyuck Yang, Daegu (KR)

(72) Inventor: Jae-hyuck Yang, Daegu (KR)

(21) Appl. No.: 15/850,527

(22) Filed: Dec. 21, 2017

(30) Foreign Application Priority Data
Jul. 28, 2017 (KR) 10-2017-0096080

(51) Int. Cl. G06F 17/30; G06Q 30/02; G06Q 50/00; H04W 4/00; G06F 3/0488; G06Q 30/06

(52) U.S. Cl. CPC G06F 17/30268; G06Q 30/0277; G06Q 30/0251; G06Q 30/0643; H04W 4/008; G06F 3/0488; G06Q 50/01

(57) ABSTRACT

The present invention relates to an advertising method and system which share information including tag contents. An aspect of the present invention provides an advertising method which shares information including a tag content including: a first step of setting a first area in a first content displayed on a first terminal; a second step of receiving first information related to at least one item included in the first area and second information related to a link through which at least one item is purchasable, from a server, by the first terminal; a third step of displaying a tag content associated with the first information on a first area of the first terminal; a fourth step of transmitting a first content in which the tag content is displayed, to a second terminal, by the first terminal; a fifth step of selecting the tag content in the first content in the second terminal; and a sixth step of displaying a link of the second information in the second terminal.

### TECHNICAL FIELD

The present invention relates to an advertising method and system which share information including tag contents, and more particularly, to an advertising method and system which share information including tag contents representing a specific area and a brand or product and connect to a link related to a brand or product when a sharing user selects a specific area.

### BACKGROUND ART

Advertising is an information activity which is invested by a company, an individual, or an organization by informing products, services, ideologies, creeds, or policies to the world to achieve desired purposes and also is a sort of a persuasive communication activity which promotes sales by informing a large number of consumers of the presence of goods or services.

Advertising is an activity which posts or broadcasts expression messages such as texts, pictures, photographs, drawings, images, and sounds to various mass media such as newspapers, magazines, radio, or television or transmission media such as mails, posters, pamphlets, outdoor advertising, theaters, or Internet and thus broadly transmits and persuades information contents on products and services to prospective buyers to promote achievement of desired purposes such as sales.

Such advertising is performed to stimulate a demand of a consumer to buy a product or a service or apply an image to the product or is tried to enhance an image of the company or performed for a political purpose or public services.

Profit-seeking advertising refers to normal commercial advertising which is performed to sell products and non-profit advertising is a non-commercial advertising by public organizations such as Red Cross or public advertising agencies and is generally referred to as a public advertising or public service advertising.

Further, the advertising is mainly classified into product advertising (or sales advertising) or non-product advertising according to a purpose or a function. The product advertising is advertising for promoting sales of products or services produced by a company.

In contrast, the non-product advertising is advertising which causes a general public to recognize social contribution or importance of a company management of an advertiser to gain their favor or trust and is generally referred to as corporate advertising or image advertising.

In the meantime, according to a current advertising technique, there is a problem in that only advertising for a specific product or brand is performed but a user cannot promptly figure out information on a desired product or link information for buying a desired product by watching texts, images, or moving images, but needs to perform a separate searching process.

Therefore, in order to solve the above-mentioned problem, currently, an advertising method which connects users to a link related to a brand or product when users share information including tag contents representing a specific area and a brand or product and the sharing users select the specific area is required.

### RELATED ART DOCUMENT

### Patent Document

(Patent Document 1) Korean Patent Application No. 10-2001-0073484.

(Patent Document 2) Korean Patent Registration No. 10-0496514.

### DISCLOSURE

### Technical Problem

The present invention provides an advertising method and system which share information including tag contents to a user.

Specifically, the present invention provides an advertising method and system which connect users to a link related to a brand or product when users share information including tag contents representing a specific area and a brand or product and the sharing users select the specific area, to the user.

In the meantime, other technical objects to be achieved in the present invention are not limited to the aforementioned technical objects, and other not-mentioned technical objects will be obviously understood by those skilled in the art from the description below.

### Technical Solution

According to an aspect of the present invention, there is provided an advertising method which shares information including tag contents, including: a first step of setting a first area in a first content displayed on a first terminal; a second step of receiving first information related to at least one item included in the first area and second information related to a link through which at least one item is purchasable, from a server, by the first terminal; a third step of displaying a tag content associated with the first information on a first area of the first terminal; a fourth step of transmitting a first content in which the tag content is displayed, to a second terminal, by the first terminal; a fifth step of selecting the tag content in the first content in the second terminal; and a sixth step of displaying a link of the second information in the second terminal.

Further, the first content may include a text, an image, or a moving image, a plurality of first areas and tag contents may be provided, and a plurality of second terminals may be provided.

Further, before the first step, the method may further include a 0.5-th step of registering brand and product information related to a plurality of items and link information through which the plurality of items is purchased in the server.

Further, the first step includes: a 1-1 step of touching a first point in the first content displayed on the first terminal; a 1-2 step of touching the first point again by drawing a closed curve while touching the first point; and a 1-3 step of setting the closed curve based on the first point as the first area.

Further, a size and a position of the closed curve in the 1-3 step may be changeable.

Further, the tag content in the third step may be displayed on the first area as a brand image of at least one item.

Further, after the sixth step, the method may further include: a seventh step of determining an advertising cost by the server using at least one of the number of transmitting in the fourth step and the number of selecting the tag content in the fifth step.

Further, at least one of a short distance communication and a long range communication may be used between the terminal and the server, the short distance communication may include ANT, a Bluetooth, a radio frequency identification (RFID), an infrared data association (IrDA), an ultra wideband (UWB), a ZigBee technique, and the long range communication may include code division multiple access (CDMA), frequency division multiple access (FDMA), time division multiple access (TDMA), orthogonal frequency division multiple access (OFDMA), and single carrier frequency division multiple access (SC-FDMA).

According to another aspect of the present invention, there is provided a system which shares information including tag contents, including a plurality of terminals and a server which configures a network with the plurality of terminals in which a first terminal among the plurality of terminals may set a first area in a displayed first content, receive first information related to at least one item included in the first area and second information related to a link through which at least one item is purchasable, display a tag content associated with the first information on the first area, and transmit a first content in which the tag content is displayed to a second terminal and when the tag content in the first content is selected, the second terminal among the plurality of terminals may display a link of the second information.

### Advantageous Effects

The present invention may provide an advertising method and system which share information including tag contents to a user.

Specifically, the present invention provides an advertising method and system which connect users to a link related to a brand or product when users share information including tag contents representing a specific area and a brand or product and the sharing users select a specific area, to the user.

In the meantime, effects to be achieved in the present invention are not limited to the aforementioned effects, and other not-mentioned effects will be obviously understood by those skilled in the art from the description below.

### DESCRIPTION OF DRAWINGS

FIG. 1 is a block diagram for explaining a configuration of a terminal which is applicable to the present invention.

FIG. 2 is a block diagram for explaining an advertising system which shares information including tag contents suggested by the present invention.

FIG. 3 is a view for explaining a connection relationship of an advertising system which shares information including tag contents explained in FIG. 2.

FIG. 4 is a flowchart for explaining an advertising method which shares information including tag contents suggested by the present invention.

FIGS. 5A and 5B are views for explaining a step of setting a specific area in a first content displayed on a terminal by a user explained in FIG. 4.

FIG. 6 is another view for explaining a step of setting a specific area in a first content displayed on a terminal by a user explained in FIG. 4.

FIGS. 7A, 7B and 7C are views for explaining a step of setting a brand for at least one product or a product included in the specific area explained in FIG. 4.

FIGS. 8A, 8B, 8C and 8D are views for explaining a step of setting a link related to purchase of a brand or product set as explained in FIG. 4.

FIG. 9 is a view illustrating a step of displaying a second content representing the specific area and the brand or product explained in FIG. 4 on a user terminal together with a first content.

FIGS. 10A and 10B are other views illustrating a step of displaying a second content representing the specific area and the brand or product explained in FIG. 4 on a user terminal together with a first content.

FIG. 11 is a view illustrating a step of sharing a first content including a second content with a plurality of terminals by the user explained in FIG. 4 using a terminal.

### BEST MODE

The following technology may be used for various multiple access schemes such as code division multiple access (CDMA), frequency division multiple access (FDMA), time division multiple access (TDMA), orthogonal frequency division multiple access (OFDMA), single carrier-FDMA (SC-FDMA), and the like. The CDMA may be implemented by a radio technology such as universal terrestrial radio access (UTRA) or CDMA2000. The TDMA may be implemented by a radio technology such as global system for mobile communications (GSM)/general packet radio service (GPRS)/enhanced data rates for GSM evolution (EDGE). The OFDMA may be implemented by a radio technology such as IEEE (Institute of Electrical and Electronics Engineers) 802.11(Wi-Fi), IEEE 802.16(WiMAX), IEEE 802.20, or E-UTRA (Evolved UTRA). The UTRA is a part of a universal mobile telecommunication system (UMTS). 3rd generation partnership project (3GPP) long term evolution (LTE) as a part of an evolved UMTS (E-UMTS) using E-UTRA adopts the OFDMA in a downlink and the SC-FDMA in an uplink. LTE-advanced (A) is an evolution of the LTE. IEEE 802.16m is an evolution of IEEE 802.16e.

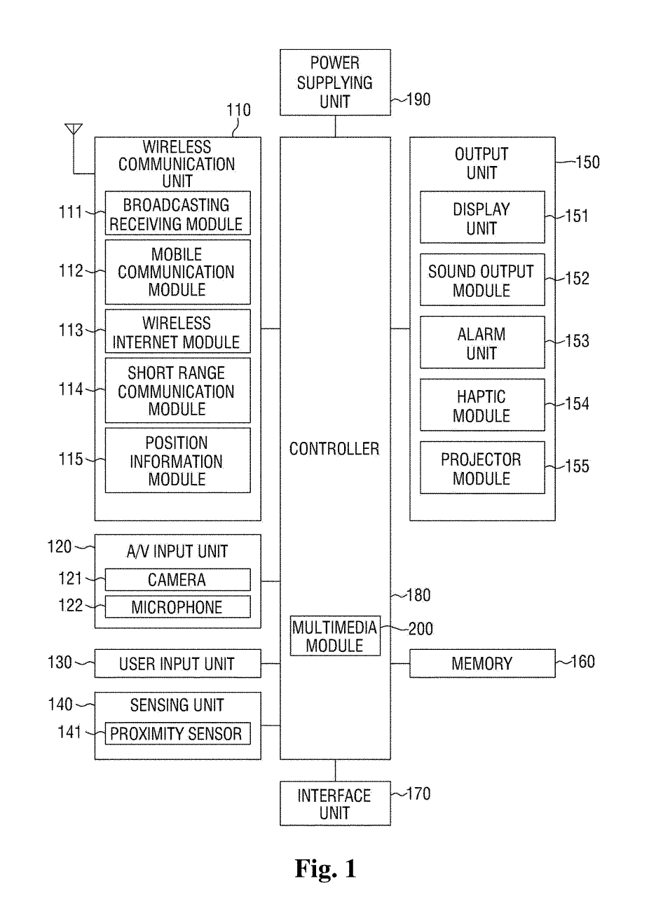

FIG. 1 is a block diagram for explaining a configuration of a terminal which is applicable to the present invention.

A terminal illustrated in FIG. 1 may include a wireless communication unit 110, an audio/video (A/V) input unit 120, a user input unit 130, a sensing unit 140, an output unit 150, a memory 160, an interface unit 170, a controller 180, and a power supplying unit 190. Since the components illustrated in FIG. 1 are not essential, a terminal having more components or fewer components may be implemented.

Hereinafter, the above-mentioned components will be described in sequence.

The wireless communication unit 110 may include one or more modules which enable wireless communication between a terminal and a wireless communication system or between a terminal and a network where the terminal is located. For example, the wireless communication unit 110 may include a broadcasting receiving module 111, a mobile communication module 112, a wireless internet module 113, a short range communication module 114, and a position information module 115.

The broadcasting receiving module 111 receives a broadcasting signal and/or broadcasting related information from an external broadcasting management server through a broadcasting channel.

The broadcasting channel may include a satellite channel and a terrestrial wave channel. The broadcasting management server may refer to a server which generates and transmits the broadcasting signal and/or the broadcasting related information or a server which receives a previously generated broadcasting signal and/or broadcasting related information to transmit the broadcasting signal and/or broadcasting related information to the terminal. The broadcasting signal may include not only a TV broadcasting signal, a radio broadcasting signal, and a data broadcasting signal, but also a broadcasting signal in which the data broadcasting signal is combined with the TV broadcasting signal or the radio broadcasting signal.

The broadcasting related information may refer to information on a broadcasting channel, a broadcasting program, or a broadcasting service provider. The broadcasting related information may also be provided through a mobile communication network. In this case, the broadcasting related information may be received by the mobile communication module 112.

There are various types of broadcasting related information. For example, the broadcasting related information may be an electronic program guide (EPG) of digital multimedia broadcasting (DMB) or an electronic service guide (ESG) of a digital video broadcast-handheld (DVB-B).

The broadcasting receiving module 111 may receive a digital broadcasting signal using a digital broadcasting system such as a digital multimedia broadcasting-terrestrial (DMB-T) system, a digital multimedia broadcasting-satellite (DMB-S) system, a media forward link only (MediaFLO) system, a digital video broadcast-handheld (DVB-H) system, or an integrated services digital broadcast-terrestrial (ISDB-T) system. The broadcasting receiving module 111 may also be configured to be suitable not only for the above-described digital broadcasting system, but also for other broadcasting system.

The broadcasting signal and/or broadcasting related information which are received by the broadcasting receiving module 111 may be stored in the memory 160.

The mobile communication module 112 transmits/receives a wireless signal to/from at least one of a base station, an external terminal, and a server in a mobile communication network. The wireless signal may include a voice call signal, a video communication call signal, or various types of data in accordance with transmission/reception of a text/multimedia message.

The wireless internet module 113 refers to a module for wireless internet connection and may be installed in the terminal or installed in the outside of the terminal. As a wireless internet technology, wireless LAN (WLAN) (Wi-Fi), wireless broadband (Wibro), world interoperability for microwave access (Wimax), or high speed downlink packet access (HSDPA) may be used.

The short range communication module 114 refers to a module for short range communication. As a short range communication technology, a Bluetooth, a radio frequency identification (RFID), an infrared data association (IrDA), an ultra wideband (UWB), a ZigBee, and the like may be used.

The position information module 115 is a module for obtaining a position of the terminal and a representative example thereof is a global position system (GPS) module.

Referring to FIG. 1, the audio/video (A/V) input unit 120 is a device which inputs an audio signal or a video signal and may include a camera 121 and a microphone 122. The camera 121 processes an image frame such as a still image or a moving image which is obtained by an image sensor in a video communication mode or a photographing mode. The processed image frame may be displayed on the display unit 151.

The image frame which is processed in the camera 121 may be stored in the memory 160 or transmitted to the outside through the wireless communication unit 110. Two or more cameras 121 may be provided depending on a usage environment.

The microphone 122 receives an external sound signal by a microphone in a call mode, a recording mode, or a voice recognizing mode to process the sound signal as electrical voice data. In the case of the call mode, the processed voice data is converted to be transmitted to a mobile communication base station through the mobile communication module 112 to be output. In the microphone 122, various noise removal algorithms which remove noises generated while receiving an external sound signal may be implemented.

The user input unit 130 generates input data which allows a user to control an operation of the terminal. The user input unit 130 may be configured by a keypad, a dome switch, a touch pad (static pressure/ static electricity), a jog wheel, a jog switch, and the like.

The sensing unit 140 detects a current status of the terminal such as an open/closed state of the terminal, a position of the terminal, whether a user is in contact with the terminal, an orientation of the terminal, acceleration/reduction of the terminal to generate a sensing signal for controlling an operation of the terminal. For example, when the terminal is a slide phone type terminal, the sensing unit 140 may sense whether the slide phone is open or closed. Further, the sensing unit 140 may sense whether the power supplying unit 190 supplies power or whether the interface unit 170 is coupled to an external device. In the meantime, the sensing unit 140 may include a proximity sensor 141.

The output unit 150 generates outputs related to sight, hearing, or touch and includes the display unit 151, a sound output module 152, an alarm unit 153, a haptic module 154, and a projector module 155.

The display unit 151 displays (outputs) information which is processed in the terminal. For example, when the terminal is in a phone call mode, the display unit displays a UI (user interface) or a GUI (graphic user interface) related to the phone call. When the terminal is in a video call mode or a photographing mode, the display unit displays a photographed and/or received image, a UI or a GUI.

The display unit 151 may include at least one of a liquid crystal display (LCD), a thin film transistor liquid crystal display (TFT-LCD), an organic light emitting diode (OLED), a flexible display, and a 3D display.

Some of the above-mentioned displays may be configured as a transparent type or a light transmissive type display so as to see the outside therethrough. This may be called a transparent display and a representative example of the transparent display may be a transparent OLED (TOLED). A rear side structure of the display unit 151 may also be configured as a light transmissive structure. According to this structure, the user may see an object located at a rear side of a terminal body through an area occupied by the display unit 151 of the terminal body.

Two or more display units 151 may be provided in accordance with an implementation type of the terminal. For example, in the terminal, a plurality of display units may be disposed to be spaced apart from each other or to be integrated on one surface or may be disposed on different surfaces, respectively.

When the display unit 151 and a sensor (hereinafter, referred to as a “touch sensor”) which senses a touch operation form a layered structure (hereinafter, referred to as a “touch screen”), the display unit 151 may be used as an input device in addition to the output device. For example, the touch sensor may be formed by a touch film, a touch sheet, or a touch pad.

The touch sensor may be configured to convert a change in a pressure which is applied to a specific part of the display unit 151 or an electrostatic capacity generated in a specific part of the display unit 151 into an electric input signal. The touch sensor may be configured to detect not only a touched position and a touched area but also a pressure at the time of touch.

When there is a touch input to the touch sensor, corresponding signal(s) are sent to a touch controller. The touch controller processes the signal(s) and then transmits corresponding data to the controller 180. By doing this, the controller 180 may confirm which area of the display unit 151 is touched.

The proximity sensor 141 may be disposed in an internal area of the terminal which is enclosed by the touch screen or in the vicinity of the touch screen. The proximity sensor refers to a sensor which detects whether there is an object approaching a predetermined detecting surface or an object present in the vicinity thereof using force of an electromagnetic field or infrared ray, without using mechanical contact. The proximity sensor has a longer lifespan and higher utilization than those of a contact type sensor.

Examples of the proximity sensor include a transmission type photoelectric sensor, a direct reflection type photoelectric sensor, a mirror reflection type photoelectric sensor, a high frequency oscillation type proximity sensor, a capacitive proximity sensor, a magnetic proximity sensor, and an infrared proximity sensor. When the touch screen is an electrostatic sensor, the touch screen is configured to detect proximity of the pointer by a change in an electric field according to the proximity of the pointer. In this case, the touch screen (touch sensor) may be classified as a proximity sensor.

Hereinafter, for convenience of description, a behavior in which a pointer approaches the touch screen without being in contact with the touch screen so that it is recognized that the pointer is located on the touch screen is referred to as “proximity touch” and a behavior in which the pointer is actually in contact with the touch screen is referred to as “contact touch”. A position where proximity touch on the touch screen is achieved by a pointer refers to a position where the pointer vertically corresponds to the touch screen when the pointer is proximately touched.

The proximity sensor senses proximity touch and a proximity touch pattern (for example, a proximity touch distance, a proximity touch direction, a proximity touch speed, a proximity touch time, a proximity touch position, and a proximity touch movement status). Information corresponding to the sensed proximity touch operation and proximity touch pattern may be output on the touch screen.

The sound output module 152 may output audio data which is received from the wireless communication unit 110 in the call signal receiving mode, the phone call mode, the recording mode, the voice recognizing mode, or the broadcasting receiving mode or stored in the memory 160. The sound output module 152 outputs a sound signal related to a function (for example, a call signal reception sound or a message reception sound) performed in the terminal. The sound output module 152 may include a receiver, a speaker, a buzzer, and the like.

The alarm unit 153 outputs a signal for notifying that an event of the terminal is generated. Examples of the event generated in the terminal include call signal reception, message reception, key signal input, and touch input. The alarm unit 153 may output another type of signal other than the video signal or the audio signal, for example, a signal for notifying that the event is generated, by vibration. The video signal or the audio signal may be output through the display unit 151 or the voice output module 152 so that the display unit 151 or the voice output module 152 may also be classified as a part of the alarm unit 153.

The haptic module 154 generates various tactile effects that the user may feel. A representative example of the tactile effect generated by the haptic module is vibration. An intensity and a pattern of the vibration generated by the haptic module 154 may be controlled. For example, different vibrations may be combined to be output or sequentially output.

The haptic module 154 may generate various tactile effects such as pin arrangement which vertically moves with respect to a contact skin, injection force or suction force of an air through an injecting port or a suction port, brush on a skin surface, contact of an electrode, an effect by stimulation such as electrostatic force, and effect by reproducing cold/warm sensation using heat absorbing or heatable element, in addition to vibration.

The haptic module 154 may be implemented not only to transmit a tactile effect through direct contact, but also to allow the user to feel the tactile effect through a muscular sense such as a finger or an arm. Two or more haptic modules 154 may be provided according to an configuring aspect of the portable terminal.

The projector module 155 is a component which performs an image project function using the terminal and displays an image which is same as or at least partially different from the image displayed on the display unit 151 on an external screen or a wall in accordance with the control signal of the controller 180.

Specifically, the projector module 155 may include a light source (not illustrated) which generates light (for example, laser light) for outputting an image to the outside, an image generating unit (not illustrated) which generates an image to be output to the outside using light generated by the light source, and a lens (not illustrated) which expands and outputs the image at a predetermined focal distance. Further, the projector module 155 may include a device (not illustrated) which mechanically moves the lens or the entire modules to adjust an image projecting direction.

The projector module 155 may be classified into a cathode ray tube (CRT) module, a liquid crystal display (LCD) module, and a digital light processing (DLP) module depending on a device type of the display unit. Specifically, in the DLP module, light generated in the light source is reflected by a digital micromirror device (DMD) chip to enlarge and project the generated image so that it is advantageous to reduce a size of the projector module 151.

Desirably, the projector module 155 may be provided at a side, a front side, or a rear side of the terminal in a length direction. However, it is needless to say that the projector module 155 may be provided at any position of the terminal as needed.

The memory unit 160 may store a program for processing and controlling the controller 180 and perform a function for temporarily storing data to be input/output (for example, a contact list, a message, an audio, a still image, or a moving image). The memory unit 160 may also store usage frequency (for example, usage frequency of the phone book, the message, and the multimedia) for the data. Further, the memory unit 160 also store data related to various patterns of vibration and sound which are output at the time of touch input on the touch screen.

The memory 160 may include at least one storing medium of a flash memory type, a hard disk type, a multimedia card micro type, a card type memory (for example, an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. However, the terminal may operate in association with a web storage which performs a storage function of the memory 160 on the Internet.

The interface unit 170 serves as a passage to all external apparatuses which are connected to the terminal. The interface unit 170 receives data or power from the external apparatus to transmit the data or power to each component in the terminal or transmits the data in the terminal to the external equipment. For example, the interface unit 170 may include a wired/wireless headset port, an external charger port, a wired/wireless data port, a memory card port, a port connecting devices with identification modules, an audio input/output (I/O) port, a video input/output (I/O) port, an earphone port, and the like.

The identification module is a chip which stores various information for authenticating a permission of the terminal and may include a user identity module (UIM), a subscriber identity module (SIM), a universal subscriber identity module (USIM), and the like. A device in which the identification module is provided (hereinafter, identification device) may be manufactured as a smart card. Therefore, the identification device may be connected to the terminal through a port.

When the mobile terminal is connected to an external cradle, the interface unit may serve as a passage through which power from the cradle is supplied to the mobile terminal or various command signals input from the cradle by the user is transmitted to the mobile terminal. Various command signals input from the cradle or the corresponding power may also operate by a signal for recognizing that the mobile terminal is accurately installed on the cradle.

The controller 180 generally controls an overall operation of the terminal. For example, the controller 180 performs related control and process for voice call, data communication, and video call. The controller 180 may include a multimedia module 181 for reproducing a multimedia. The multimedia module 181 may be implemented in the controller 180 or separately implemented from the controller 180.

The controller 180 may perform a pattern recognition process for recognizing a handwriting input or a drawing input performed on the touch screen as characters and images, respectively.

The power supplying unit 190 is applied with external power and internal power by the control of the controller 180 to supply power required for operations of the components.

Various exemplary embodiments described herein may be implemented in a recording medium which is readable by a computer or other similar device using a software, a hardware, or a combination thereof.

According to a hardware implementation, the exemplary embodiment described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units for performing other functions. In some cases, the exemplary embodiments described in this specification may be implemented by the controller 180 itself.

According to a software implementation, exemplary embodiments such as procedures and functions described in this specification may be implemented by separate software modules. The software modules may perform one or more functions and operations described in this specification. A software code may be implemented by a software application which is written by an appropriate program language. The software code may be stored in the memory 160 and executed by the controller 180.

Hereinafter, an advertising system which shares information including tag contents will be described in detail based on a configuration of the above-described terminal 100.

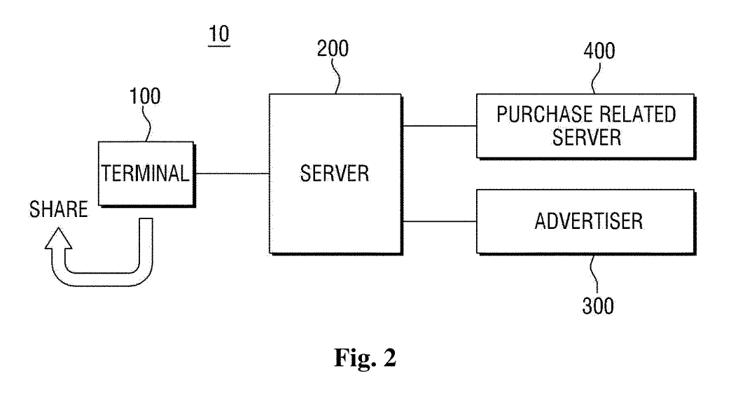

FIG. 2 is a block diagram for explaining an advertising system which shares information including tag contents suggested by the present invention.

Referring to FIG. 2, the advertising system 10 which shares information including tag contents suggested by the present invention includes the terminal 100 described using FIG. 1, a server 200, an advertiser 300, and a purchase related server 400.

A plurality of terminals may be applied to the advertising system 10 which shares information including tag contents according to the present invention and each terminal 100 may share information including tag contents with at least one other terminal 100.

Referring to FIG. 2, the advertiser 300 is a principal agent who sells at least one product based on a brand. It is possible to register a brand that the advertiser 300 wants to sell and at least one product associated with the brand in the server 200 in advance.

Further, the purchase related server 400 is a server which is capable of communicating with the server 200 and the advertiser 300 and connects a site or link through which a brand that the advertiser 300 desires to sell and at least one product associated with the brand can be sold.

Similarly to the advertiser 300, the purchase related server 400 is also capable of registering at least one link through which a brand of the advertiser 300 and at least one product associated with the brand is purchased, in the server 200 in advance.

Further, the terminal 100 designates an area desired by a user in a basic content such as a text, an image, and a moving image and receives brand or product information related to an item included in the designated area from the server 200.

Further, the terminal 100 displays the specific area designated on the basic content and a content representing a brand or product together. The specific area designated on the basic content and a content representing a brand or product are referred to as a tag content in this specification.

A link associated with the brand or product is designated in the tag content through communication between the terminal 100 and the server 200.

Further, when the user of the terminal 100 shares the tag content with a user of at least one other terminal 100 and the user of at least one other terminal 100 selects the shared tag content, the tag content is displayed to be connected to the link associated with the brand or product.

The terminal 100, the server 200, the purchase related server 400, and the advertiser 300 communicate with each other through short range communication or long range communication.

Here, the short range communication may include ANT, a Bluetooth, a radio frequency identification (RFID), an infrared data association (IrDA), an ultra wideband (UWB), and a ZigBee technique.

Further, the long range communication may include code division multiple access (CDMA), frequency division multiple access (FDMA), time division multiple access (TDMA), orthogonal frequency division multiple access (OFDMA), and single carrier frequency division multiple access (SC-FDMA).

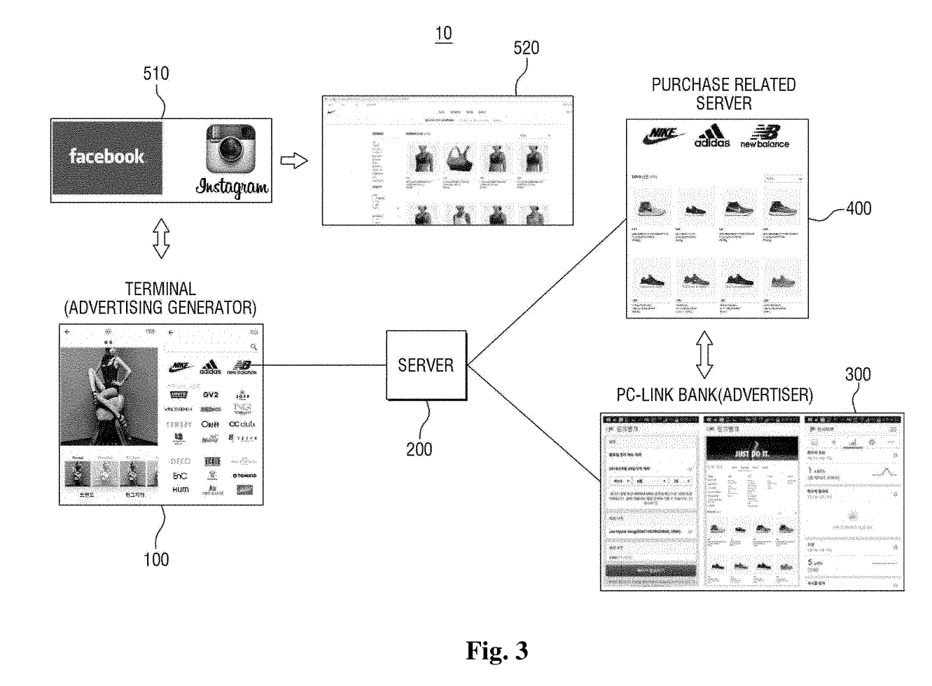

Further, FIG. 3 is a view for explaining a connection relationship of an advertising system which shares information including tag contents explained in FIG. 2.

Further, referring to FIG. 3, the advertiser 300 may register a brand which is desired to sell by the advertiser 300 and at least one product associated with the brand in the server 200 in advance.

Further, the purchase related server 400 may communicate with the server 200 and the advertiser 300 and connects a site or a link through which the brand desired by the advertiser 300 to sell and at least one product associated with the brand can be sold.

Referring to FIG. 3, similarly to the advertiser 300, the purchase related server 400 may register at least one link through which a brand of the advertiser 300 and at least one product associated with the brand can be purchased, in the server 200 in advance.

Further, referring to FIG. 3, the terminal 100 displays the specific area designated on the basic content and a content representing the brand or product together. Such a tag content is shared (510) by the user of the terminal 100 and a user of at least one other terminal 100. When the terminal of at least one other terminal 100 selects the shared tag content, the tag content is displayed to be connected to the link 520 associated with the brand or product.

A specific operation of the present invention will be described with reference to the drawings.

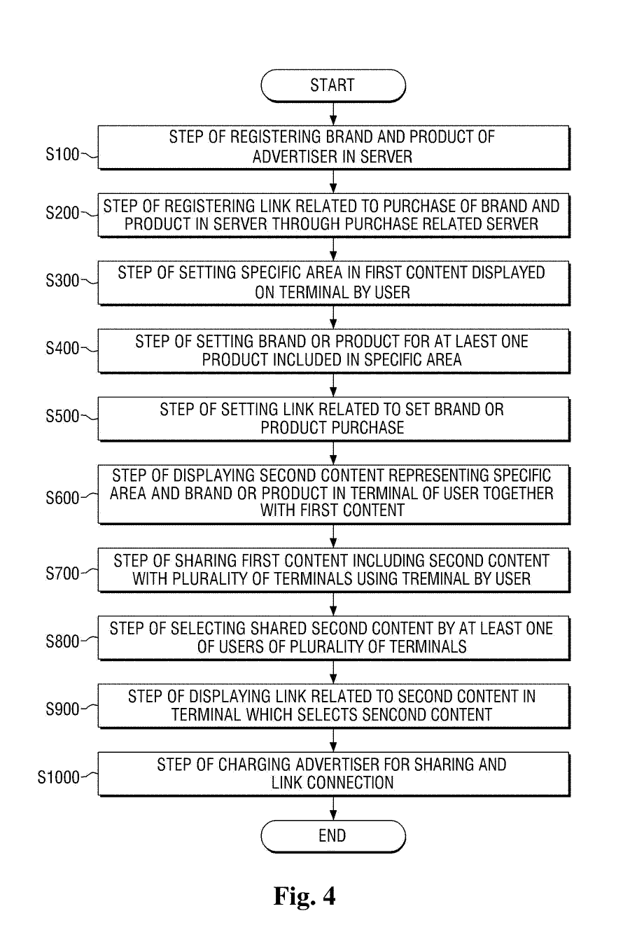

FIG. 4 is a flowchart for explaining an advertising method which shares information including tag contents suggested by the present invention.

Referring to FIG. 4, first, a step S100 of registering a brand and a product of the advertiser 300 in the server 200 is performed.

For example, when a brand desired by the advertiser 300 is Nike and products to be sold through a brand of Nike are a1, a2, and a3, the advertiser 300 may register information on Nike and the products a1, a2, and a3 in the server 200 in advance.

Next, a step S200 of registering a link 520 related to purchase of the brand and the product in the server 200 through the purchase related server 400 is performed.

For example, the advertiser 300 may register information on a plurality of links through which Nike and the products al, a2, and a3 registered in the server 200 in advance can be purchased, in the server 200 through the purchase related server 400.

After step S200, a step S300 of setting a specific area in a first content displayed on the terminal 100 by a user of the terminal 100 is performed.

The first content displayed on the terminal 100 may include a text, an image, or a moving image.

In this specification, for the convenience of description, it is assumed that the first content is an image, but the content of the present invention is not limited thereto.

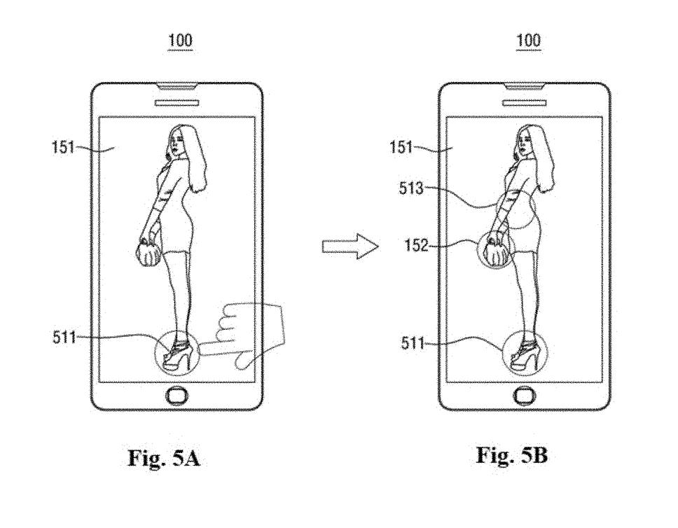

In relation to step S300, FIGS. 5A and 5B are views for explaining a step of setting a specific area in a first content displayed on a terminal by a user explained in FIG. 4.

Referring to FIG. 5A, the user of the terminal 100 designates a first area 511 in the image displayed on the display unit 151 using a pointer.

As a method of designating the first area 511, a user may set the first area using a hand or a pen.

In this case, the area may be set to a clickable range and may be designated as a free curve and polygon.

Further, when a starting portion of the touch area and an end portion meet, the touch area acts as a setting area and a size and a range thereof may be modified in the designated area.

As described above, the designated area may be registered by searching products of a TAG server 200. Further, exceptionally, a product may be searched from a browser to be linked.

A tag image designated by the above-described setting is illustrated in FIG. 5B.

Referring to FIG. 5B, a first area 511, a second area 152, and a third area 513 are designated by the user of the terminal 100 and are displayed on the display unit 151.

In the meantime, a figure which may be selected by the user in accordance with control of the controller 180 without using touch input or a separate tool may be displayed on the display unit.

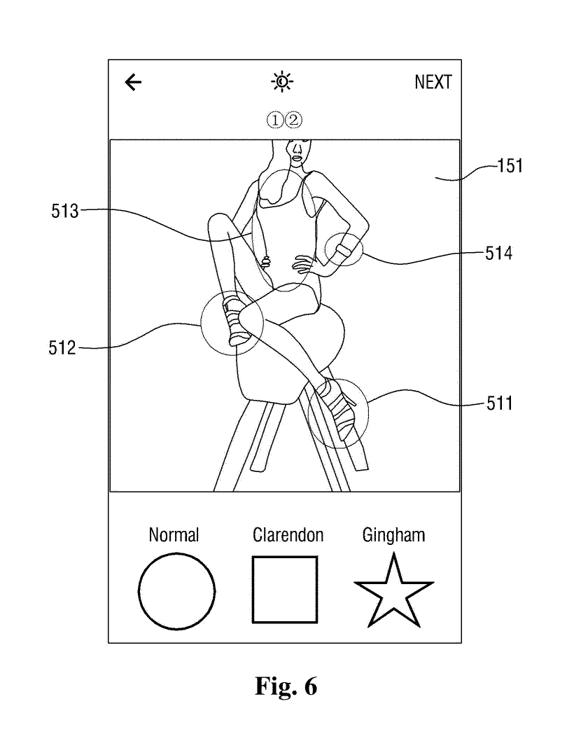

FIG. 6 is another view for explaining a step of setting a specific area in a first content displayed on a terminal by a user explained in FIG. 4.

Referring to FIG. 6, a plurality of polygons is displayed on a tag area setting menu 515 of the display unit.

When the user selects a first figure among the plurality of polygons, the selected first figure is displayed on an image and the user moves the selected first figure to set a first area 511, a second area 512, a third area 513, and a fourth area 514 on the display unit 155.

Specifically, when the user clicks and drags a figure to move the figure and then drops the figure (releases the hand), automatic search is performed and when a product or a brand is selected during the search, the user may set a next figure.

Returning to FIG. 4, after step S300, a step S400 of setting a brand for at least one product or a product included in the specific area is performed.

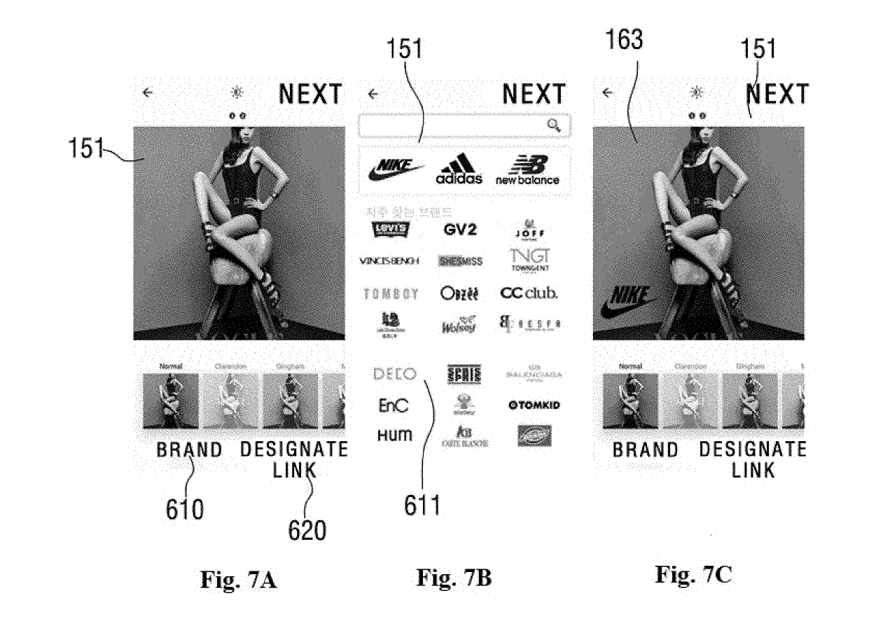

FIGS. 7A, 7B and 7C are views for explaining a step of setting a brand for at least one product or a product included in the specific area explained in FIG. 4.

Referring to FIG. 7A, as described with reference to FIG. 6, an example in which when the user selects a first figure among the plurality of polygons, the selected first figure is displayed on an image and the user moves the selected first figure to set a first area 511, a second area 512, a third area 513, and a fourth area 514 on the display unit 155 is illustrated.

Further, referring to FIG. 7B, when the user sets the first area 511, the second area 512, the third area 513, and the fourth area 514, information 611 on the brand and product of the advertiser 300 which are registered in the server 200 in advance through step S100 is displayed on the display unit 151.

In this case, the user may designate a corresponding brand and product among the plurality of information displayed on the display unit 151.

Thereafter, as illustrated in FIG. 7C, an image 163 representing the brand or product related information on the display unit is displayed in the designated area on the display unit.

Further, after step S400, a step S500 of setting a link related to the purchase of the brand or product set by the user is performed.

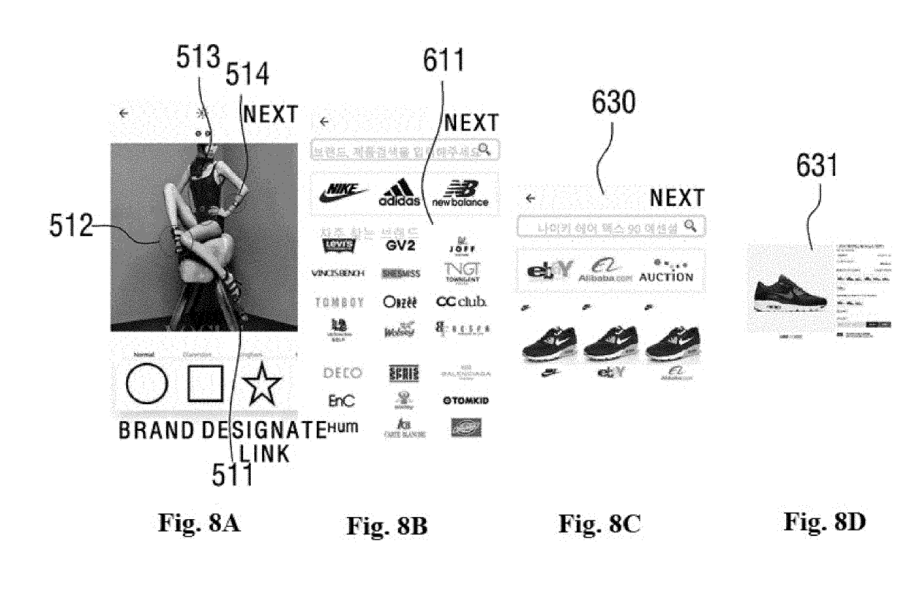

In relation to step S500, FIGS. 8A, 8B, 8C and 8D are views for explaining a step of setting a link related to purchase of a brand or a product set as explained in FIG. 4.

Since FIGS. 8A and 8B correspond to FIGS. 7A and 7B, respectively, a redundant description will be omitted for a purpose of simplification of specification.

After FIGS. 8A and 8B, as illustrated in FIG. 8C, a list 630 of links related to the purchase of the brand or product set by the user is displayed on the display unit 151.

The user may set a first link 631 from the displayed list 630 of links. When the user selects the first link 631, as illustrated in FIG. 8D, a screen which moves to the first link 631 may be displayed on the display unit 151.

When step S500 is completed, a second content representing a specific area and a brand or a product, that is, the above-described tag content is displayed on the terminal of the user together with the first content in step S600.

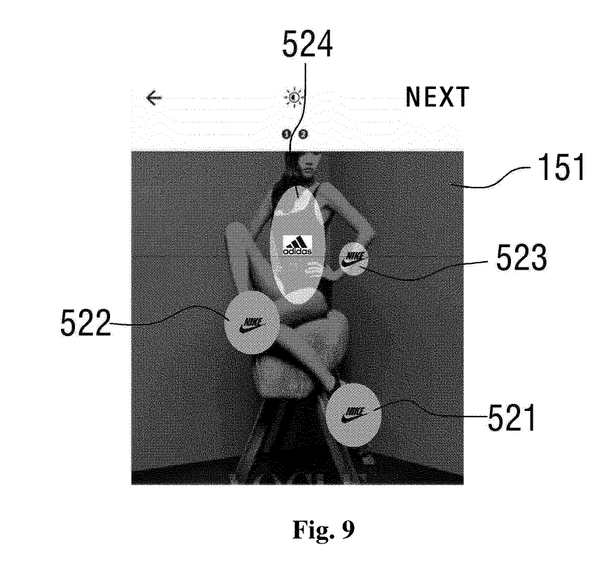

FIG. 9 is a view illustrating a step of displaying a second content representing the specific area and the brand or product explained in FIG. 4 on a user terminal together with a first content.

Referring to FIG. 9, correspondingly to step S600, a first tag content 521, a second tag content 522, a third tag content 523, and a fourth tag content 524 are disposed in a tag area designated by the user to be displayed on the display unit.

In the meantime, the plurality of tag contents may not always be displayed, but may be displayed only when a specific touch input of the user is received.

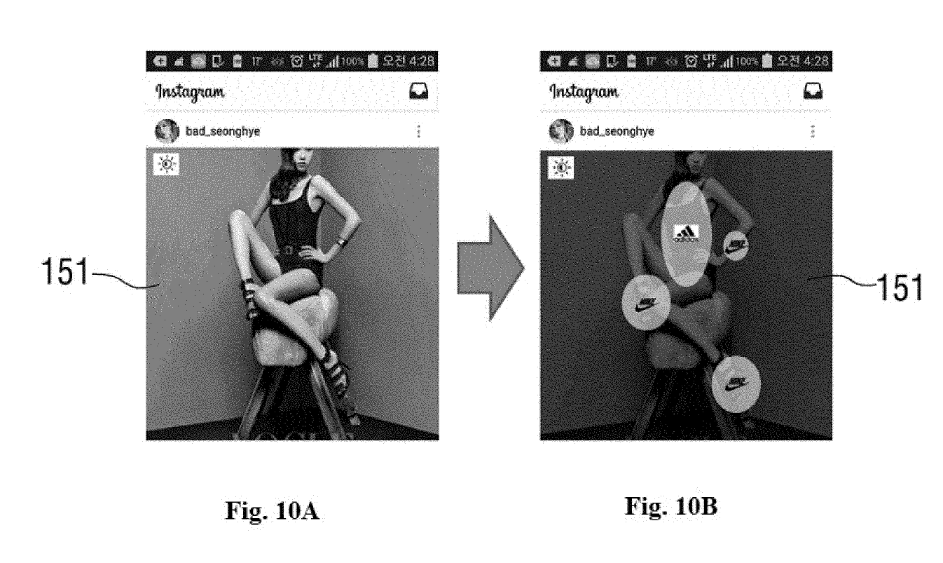

FIGS. 10A and 10B are other views illustrating a step of displaying a second content representing the specific area and the brand or product explained in FIG. 4 on a user terminal together with a first content.

Referring to FIG. 10A, generally, even when the first tag content 521, the second tag content 522, the third tag content 523, and the fourth tag content 524 are designated corresponding to step S600, only the image is displayed on the display unit 151.

In this case, the user may input a command through a touch input with a specific pattern or through a user input unit 130. As illustrated in FIG. 10B, in response to the touch input or command input, the designated first tag content 521, second tag content 522, third tag content 523, and fourth tag content 524 may be displayed.

In the meantime, in step S600, the tag content may be displayed by being classified in accordance with a selection frequency of the product or brand by a user of other terminal 100.

For example, among the displayed first tag content 521, second tag content 522, third tag content 523, and fourth tag content 524, when a brand and product corresponding to the first tag content 521 is selected by other users and frequently purchased, the first tag content 521 is displayed to be larger than other tag contents or a flickering visual effect may be applied to the first tag content.

After step S600, the user may share the first content including the second content, that is, a tag content with a plurality of other terminals 100 using the terminal 100 in step S700.

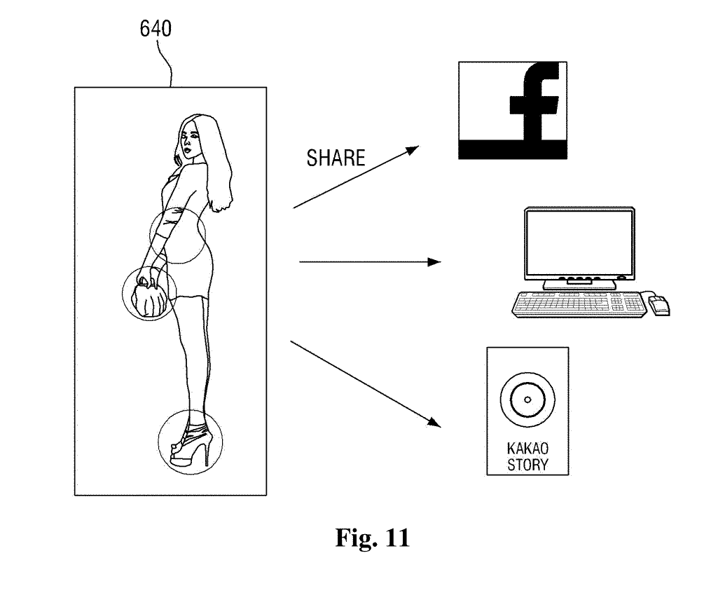

FIG. 11 is a view illustrating a step of sharing a first content including a second content with a plurality of terminals by the user explained in FIG. 4 using a terminal.

Referring to FIG. 11, the user of the terminal 100 shares not only the image, but also an image including the tag contents with users of other terminals 100 through at least one SNS.

After step S700, at least one of users of the plurality of terminals 100 may select the shared second content, that is, the tag content in step S800.

In this case, the terminal 100 which selects the second content (tag content) moves to a link associated with the second content (tag content) to be displayed on the display unit 151 in step S900 and a user of the other terminal 100 may purchase a product of interest through the moved link.

Further, the server 200 may charge the advertiser 300 an amount determined in accordance with the number of sharing actions of the user of the connected terminal 100 and the number of link connections of the other terminal users according to sharing in step S1000.

That is, when a product for a designated area is clicked in a file in which a TAG image file is shared in various types, a counter may be charged to the advertiser 300 as a market cost.

When the above-described method is applied, an advertising method and system which share information including tag contents may be provided to a user.

The present invention may provide an advertising method and system which connect users to a link related to a brand or product when users share information including tag contents representing a specific area and a brand or product and the sharing users select a specific area, to the user.

In the meantime, the above-described exemplary embodiments of the present invention may be implemented through various means. For example, the exemplary embodiments of the present disclosure may be implemented by a hardware, a firm ware, a software, and a combination thereof.

When the exemplary embodiment is implemented by the hardware, the method according to the exemplary embodiment of the present disclosure may be implemented by one or more devices of application specific integrated circuits (ASICs), digital signal processors (DSPs), digital signal processing devices (DSPDs), programmable logic devices (PLDs), field programmable gate arrays (FPGAs), a processor, a controller, a microcontroller, or a microprocessor.

When the exemplary embodiment is implemented by the firmware or the software, the method according to the exemplary embodiment of the present disclosure may be implemented by a module, a procedure, or a function which performs a function or operations described above.

The software code is stored in the memory unit to be driven by the processor. The memory unit is located inside or outside the processor and exchanges data with the processor, by various known units.

Detailed description of the exemplary embodiments of the present invention disclosed as described above is provided to allow those skilled in the art to implement and carry out the present invention. While the invention has been described with reference to the preferred embodiments, it will be understood by those skilled in the art that various changes and modifications of the present invention may be made without departing from the scope of the invention. For example, those skilled in the art may use the components described in the above-described exemplary embodiments by combining the components. Therefore, the present invention is not limited to the exemplary embodiments described here but assigns the broadest scope consistent with principles disclosed herein and novel features thereto.

The present invention may be implemented in another specific form within the scope without departing from the spirit and essential feature of the present invention. Therefore, the detailed description should not limitatively be analyzed in all aspects and should be exemplarily considered. The scope of the present invention should be determined by rational interpretation of the appended claims and all changes are included in the scope of the present invention within the equivalent scope of the present invention. Therefore, the present invention is not limited to the exemplary embodiments described here but assigns the broadest scope consistent with principles disclosed herein and novel features thereto. Further, claims having no clear quoting relation in the claims are combined to configure the embodiment or may be included as new claims by correction after application.

1. An advertising method which shares information including tag contents, the method comprising:
a first step of setting a first area in a first content displayed on a first terminal;
a second step of receiving first information related to at least one item included in the first area and second information related to a link through which at least one item is purchasable, from a server, by the first terminal;
a third step of displaying a tag content associated with the first information on a first area of the first terminal;
a fourth step of transmitting a first content in which the tag content is displayed, to a second terminal, by the first terminal;
a fifth step of selecting the tag content in the first content in the second terminal; and
a sixth step of displaying a link of the second information in the second terminal.

2. The advertising method according to claim 1, wherein
the first content includes a text, an image, or a moving image, a plurality of first areas and tag contents are provided, and a plurality of second terminals is provided.

3. The advertising method according to claim 1, further comprising:
before the first step,
a 0.5-th step of registering brand and product information related to a plurality of items and link information through which the plurality of items is purchased in the server.

4. The advertising method according to claim 1, wherein the first step includes:
a 1-1 step of touching a first point in the first content displayed on the first terminal;
a 1-2 step of touching the first point again by drawing a closed curve while touching the first point; and
a 1-3 step of setting the closed curve based on the first point as the first area.

5. The advertising method according to claim 4, wherein a size and a position of the closed curve in the 1-3 step is changeable.

6. The advertising method according to claim 1, wherein the tag content in the third step is displayed on the first area as a brand image of at least one item.

7. The advertising method according to claim 1, further comprising:
after the sixth step,
a seventh step of determining an advertising cost by the server using at least one of the number of transmitting in the fourth step and the number of selecting the tag content in the fifth step.

8. The advertising method according to claim 1, wherein at least one of a short distance communication and a long range communication is used between the terminal and the server, the short distance communication includes ANT, a Bluetooth, a radio frequency identification (RFID), an infrared data association (IrDA), an ultra wideband (UWB), a ZigBee technique, and the long range communication includes code division multiple access (CDMA), frequency division multiple access (FDMA), time division multiple access (TDMA), orthogonal frequency division multiple access (OFDMA), and single carrier frequency division multiple access (SC-FDMA).

9. An advertising system which shares information including tag contents, the advertising system comprising:
a plurality of terminals; and
a server which configures a network with the plurality of terminals,
wherein a first terminal among the plurality of terminals sets a first area in a displayed first content, receives first information related to at least one item included in the first area and second information related to a link through which at least one item is purchasable, displays a tag content associated with the first information on the first area, and transmits a first content in which the tag content is displayed to a second terminal and
when the tag content in the first content is selected, the second terminal among the plurality of terminals displays a link of the second information.
